(19) United States
(12) Patent Application Publication
(10) Pub. No.: US 2018/0205905 A1
(43) Pub. Date: Jul. 19, 2018

(54) STRUCTURAL HEALTH MONITORING SYSTEMS UTILIZING VISUAL FEEDBACK AND SELECTIVE RECORDING

(71) Applicant: Caterpillar Inc., Peoria, IL (US)

(72) Inventors: Jeremy Hammar, Metamora, IL (US); Christopher Junck, Washington, IL (US); Tilak Inturi, Dunlap, IL (US)

(73) Assignee: Caterpillar Inc., Peoria, IL (US)

(21) Appl. No.: 15/410,472

(22) Filed: Jan. 19, 2017

(51) Int. Cl. H04N 5/77; H04N 7/18; H04N 5/907; G07C 5/08; G09B 19/00

(52) U.S. Cl. CPC H04N 5/77; H04N 7/183; G09B 19/003; G07C 5/0841; G07C 5/0816; H04N 5/907

(57) ABSTRACT

A system for monitoring structural health of a machine includes sensors configured to collect structural health data associated with the machine. The system includes video cameras operatively associated with the machine and configured to selectively record video data. The system includes a controller, including a processor, operatively associated with the sensors and the video cameras. The controller is configured to receive the structural health data from the sensors and determine if one or more structural health events have occurred based on the structural health data. The controller is configured to record the video data during a timeframe associated with at least one of the one or more structural health events, if at least one of the one or more structural health events has occurred, the video data showing occurrence of at least one of the one or more structural health events, relative to the machine.

### TECHNICAL FIELD OF THE DISCLOSURE

The present disclosure generally relates to structural health monitoring systems and methods, for machines, and, more particularly, relates to utilization of video data, associated with structural health events, in such structural health monitoring systems and methods.

### BACKGROUND OF THE DISCLOSURE

Heavy machinery, such as construction machines and/or earthmoving machines (e.g., excavators, mining shovels, loaders, earth movers, bulldozers, front end loaders, motor graders, and the like) may have a plurality of structural components that may be susceptible to fatigue and/or strain that can lead to structural damage and, ultimately, structural failure. In the past, structural damage was measured in a manual, visual manner, by operators and/or fleet managers, observing the machine and/or the worksite. However, such manual inspection is not always sufficient, as the visual appearance of a structure may not be indicative of all signs of structural damage.

Accordingly, structural health monitoring systems for machines have been developed to utilize one or more sensors associated with said machines to determine structural health conditions or events (e.g., part failure, overworked cylinders, a worn surface, or any health and/or wear characteristic of a machine component). Such sensors may collect data on the worksite, associated with the machine and any components thereof, and, from said data, structural health conditions and/or events may be indicated or an analysis of said data may indicate a correlation between conditions, indicated by or derived from the data, and one or more structural health issues.

Accordingly, advancements in structural health monitoring systems have led to creation of systems utilizing a plurality of strain sensors throughout the machine, most of which are unobtrusive and often unnoticeable to the lay person. For example, the systems and methods for structural health monitoring in U.S. Pat. No. 7,908,928 (“Monitoring System”) utilizes multiple, film-thin strain sensing devices, each associated with wireless nodes, to detect wear and derive fatigue life for machine components. While systems, such as the system of the '928 patent, provide valuable, wear-related information and data, such information and data may not illustrate the entirety of a structural health event.

Accordingly, it is desired to utilize video in association with structural health monitoring to achieve further insight into the causes and determine potential solutions to structural health issues. However, continuously recording and saving video data may be computationally burdensome and/or may cause unnecessary data strain on data networks used as part of or in association with structural health monitoring systems. Therefore, systems and methods for monitoring structural health, which selectively record and store video data, are desired.

### SUMMARY OF THE DISCLOSURE

In accordance with one aspect of the present disclosure, a system for monitoring structural health of a machine is disclosed. The system may include one or more sensors configured to collect structural health data associated with the machine. The system may further include one or more video cameras operatively associated with the machine and configured to selectively record video data. The system may further include a controller, including a processor, operatively associated with the one or more sensors and the one or more video cameras. The controller may be configured to receive the structural health data from the one or more sensors and determine if one or more structural health events have occurred based on the structural health data. The controller may further be configured to record the video data during a timeframe associated with at least one of the one or more structural health events, if at least one of the one or more structural health events has occurred, the video data showing occurrence of at least one of the one or more structural health events, relative to the machine.

In accordance with another aspect of the present disclosure, a method for monitoring structural health of a machine is disclosed. The method may include collecting structural health data associated with the machine, using one or more sensors and recording video data associated with the machine, using one or more video cameras associated with the machine. The method may further include determining, by an electronic controller, if one or more structural health events have occurred, based on the structural health data. The method may further include storing, at least in part, the video data, on a memory associated with the controller, during a timeframe associated with at least one of the one or more structural health events, if at least one of the one or more structural health events has occurred, the video data showing occurrence of at least one of the one or more structural health events.

In accordance with yet another aspect of the disclosure, a machine is disclosed. The machine may include a plurality of machine components including, at least, one or more ground engaging devices, a prime mover, and an implement. The machine may further include one or more sensors configured to collect structural health data associated with one or more of the plurality of machine components. The machine may further include one or more video cameras operatively associated one or more of the plurality of machine components, the video cameras configured to selectively record video data associated with one or more of the plurality of machine components. The machine may further include a controller, including a processor, operatively associated with the one or more sensors and the one or more video cameras. The controller may be configured to receive the structural health data from the one or more sensors, receive the selectively recorded video data from the one or more video cameras, and determine if one or more structural health events have occurred based on the structural health data. The controller may further be configured to store the video data recorded by the one or more video cameras, during a timeframe associated with at least one of the one or more structural health events, if at least one of the one or more structural health events has occurred, the video data showing occurrence of at least one of the one or more structural health events, relative to one or more of the plurality of machine components.

Other features and advantages of the disclosed systems and principles will become apparent from reading the following detailed disclosure in conjunction with the included drawing figures.

### BRIEF DESCRIPTION OF THE DRAWINGS

FIG. 1 is a side view of an example machine and some elements of an example system for monitoring structural health of the machine, in accordance with an embodiment of the present disclosure.

FIG. 2 is a schematic representation of the system for monitoring structural health of the machine of FIG. 1, in accordance the present disclosure and the embodiment of FIG. 1.

FIG. 3 is a timeline intended to illustrate storage timing of video data recorded by one or more video cameras of the system of FIGS. 1 and 2, in accordance with the present disclosure and FIGS. 1 and 2.

FIG. 4 is an example schematic diagram illustrating data storage features of a controller of the system of FIGS. 1 and 2, in accordance with the present disclosure and FIGS. 1 and 2.

FIG. 5 is a side view of an example machine, upon which the systems and methods disclosed herein may be utilized to monitor structural health, in accordance with the present disclosure.

FIG. 6 is a side view of a second example machine, upon which the systems and methods disclosed herein may be utilized to monitor structural health, in accordance with the present disclosure.

FIG. 7 is a side view of a third machine, upon which the systems and methods disclosed herein may be utilized to monitor structural health, in accordance with the present disclosure.

FIG. 8 is a schematic block diagram for a method for monitoring structural health of a machine, in accordance with the present disclosure.

While the following detailed description will be given with respect to certain illustrative embodiments, it should be understood that the drawings are not necessarily to scale and the disclosed embodiments are sometimes illustrated diagrammatically and in partial views. In addition, in certain instances, details which are not necessary for an understanding of the disclosed subject matter or which render other details too difficult to perceive may have been omitted. It should therefore be understood that this disclosure is not limited to the particular embodiments disclosed and illustrated herein, but rather to a fair reading of the entire disclosure and claims, as well as any equivalents thereto.

### DETAILED DESCRIPTION OF THE DISCLOSURE

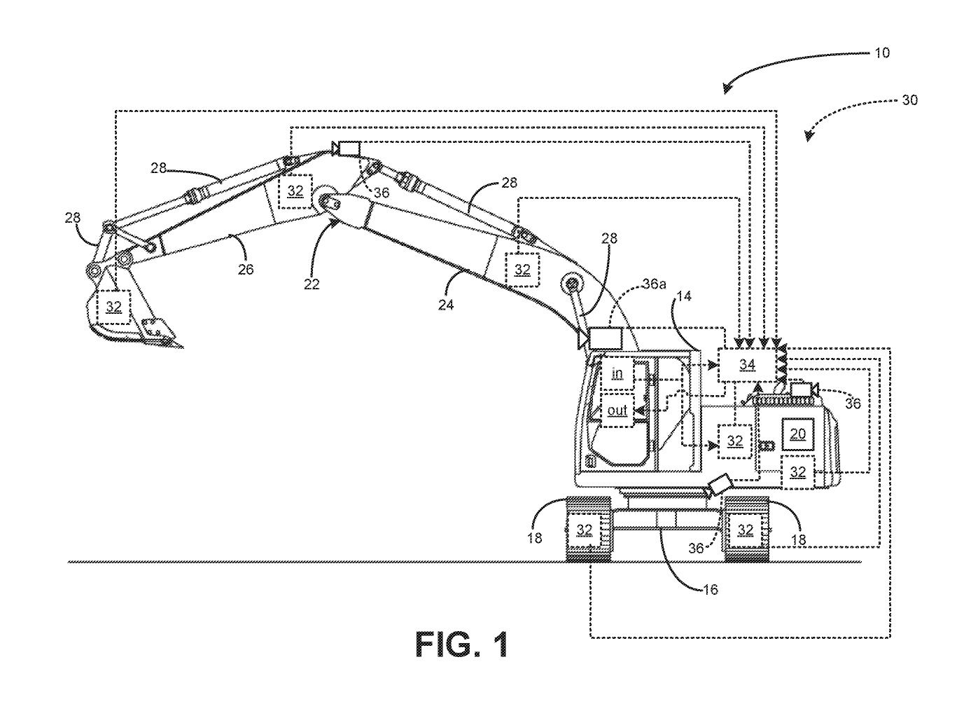

Turning now to the drawings and with specific reference to FIG. 1, a machine 10 having an implement 12 is illustrated in accordance with the teachings of the present disclosure. While the machine 10 in FIG. 1 is depicted, generally, as an excavator- type machine, the teachings of the present disclosure may relate to other work machines. The term “machine” as used herein may refer to any machine that performs some type of operation associated with an industry such as mining, construction, farming, transportation, or any other industry known in the art. For example, the machine 10 may be an earth-moving machine, a wheel loader, an excavator, a gantry machine and/or system, a dump truck, a backhoe, a material handler, or the like. Moreover, the work implement 12 connected to the machine may be utilized for a variety of tasks including, but not limited to, loading, compacting, lifting, brushing and may include, for example, buckets, compactors, forked lifting devices, brushes, grapples, cutters, shears, blades, breakers, hammers, augers, and the like.

As depicted in FIG. 1, the machine 10 may include a housing 14 disposed on top of and supported by an undercarriage 16. The undercarriage 16 may be associated with one or more ground engaging devices 18, which may be used for mobility and propulsion of the machine 10. The ground engaging devices 18 are shown as a pair of continuous tracks; however, the ground engaging devices 18 are not limited to being continuous tracks and may additionally or alternatively include other ground engaging devices such as rotatable wheels. A power system 20 is may provide power to the propel or otherwise move the ground engaging devices 18 and may include one or more power sources, such as internal combustion engines, electric motors, fuel cells, batteries, ultra-capacitors, electric generators, and/or any power source which would be known by a person having ordinary skill in the art. Such a power system 20 may further be used to power various motion of the implement 12 or any other elements and control systems associated with the machine 10 and/or implement 12.

For control of the implement 12, the machine may further include a crane 22, which may include a boom 24 operatively coupled with a stick 26. The implement 12 may be attached to the crane 22 at, for example, a distal end of the stick 26. For positioning the implement 12, the crane 22 and, as associated elements, the boom 24 and stick 26, may be controlled by any associated controllers and control systems. During control of the machine 10, the implement 12, and the crane 22, physical movement of said components may be performed using a plurality of actuators 28. The plurality of actuators 28 may include, but are not limited to including, one or more hydraulic actuators, linear actuators, electromotive actuators, and any other actuators known in the art.

During operation, machine activity and/or environmental conditions surrounding the machine 10 may impart wear, degradation, improper use, component fault, or any other machine-health related condition upon the machine 10. Accordingly, such machine-health related conditions may manifest to cause one or more structural health events to occur on or proximate to the machine 10. Structural health events may include, but are not limited to including, part failure, part wear beyond a threshold for part wear, failed actuators, improperly positioned actuators, improper component impact, and/or any other additional events that may adversely impact the health of the machine 10 or any machine components (e.g., the implement 12, the power system 20, the ground engaging devices 18, among other things).

To that end, the machine 10 may include or otherwise be associated with a structural health monitoring system (SHMS) 30, which utilizes one or more sensors 32, which are operatively associated with the machine 10, to collect structural health data associated with the machine 10. The structural health data may be received by a controller 34, which may then utilize the structural health data, determined by the sensors 32, to determine if one or more such structural health events have occurred. Elements of the SHMS 30 and the connections between such elements are depicted schematically, overlaid on the machine 10, in FIG. 1 (denoted by dotted lining). However, the specific positioning of any of the schematic elements of the SHMS are certainly not limiting and are not intended to depict actual placement of said items; rather, said placement is merely exemplary and intended to portray an understanding of the interplay between components of the machine 10 and the SHMS 30. For example, the placement of the example sensors 32 in FIG. 1 are not limiting and the sensors 32 may be placed anywhere, relative to the machine 10, in which it is desired to gather structural health data associated with the machine 10.

As depicted in FIG. 1, as also having non-limiting positions, relative to the machine 10, the SHMS 30 may further include one or more video cameras 36, each video camera 36 being operatively associated with the machine 10. The video cameras 36 may be configured to selectively record video data (e.g., “video,” “movies,” “moving images,” or any other referenced video depiction of data) associated with the machine 10. Each of the video cameras 36 may be positioned, relative to the machine 10, such that the video data recorded displays a perspective of a location on the machine 10, in which a structural health event may occur. For example, as depicted in FIG. 1, the video camera 36a may be positioned proximate to the housing 14 of the machine 10, such that it is capable of having a viewing perspective of the implement 12, such that it would be able to view the implement during occurrence of a structural health event associated with the implement 12 (e.g., excessive wear on the implement 12, a component failure of the implement, detachment of the implement or any components thereof, failure of actuators 28 associated with the implement 12, and/or any other structural health issues associated with the implement 12).

Communication and/or data communication amongst any of the elements of the SHMS 30 may be performed by any wired or wireless systems and/or methods for data communication. For example, one or more of the cameras 36 and/or sensors 32 may be equipped with wireless nodes, connected to a network and configured to transfer data wirelessly to the controller 34. However, data communication for the SHMS 30 is certainly not limited to being performed via wireless nodes and may be communicated in any other suitable fashion.

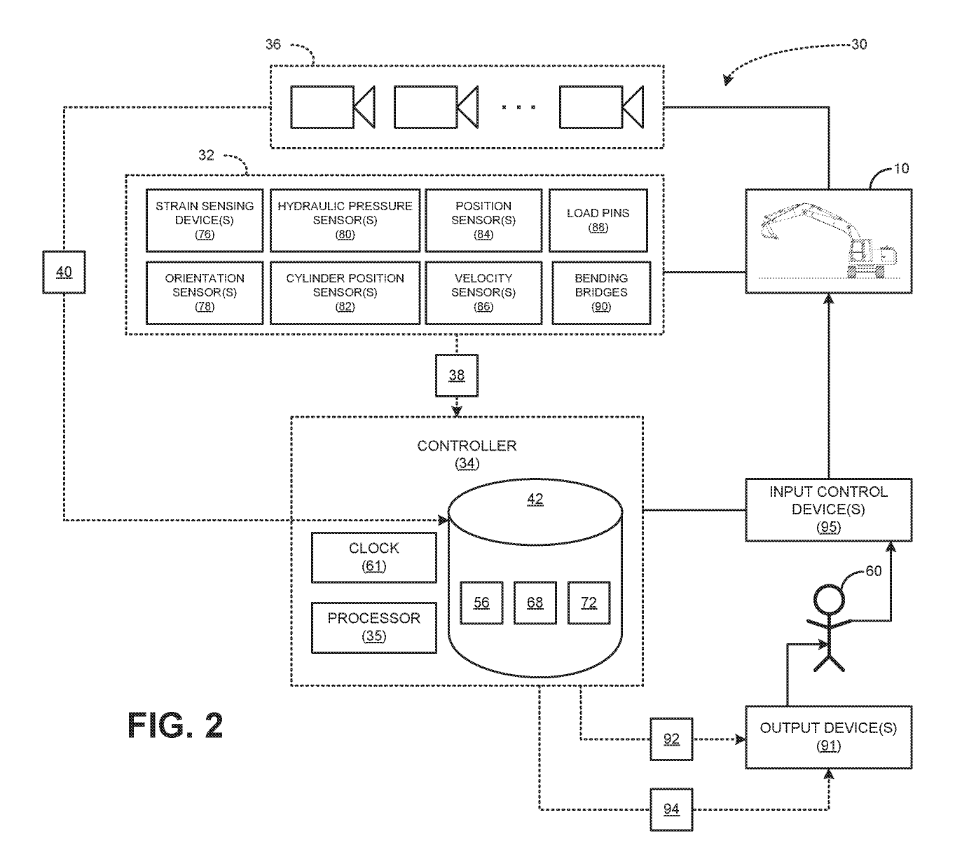

As discussed above, the controller 34 receives structural health data 38 from the sensors 32 and video data 40 from the video cameras 36, as depicted in the schematic representation of the SHMS 30 of FIG. 2. The controller 34 may be any electronic controller or computing system, including a processor 35, which operates to perform operations, execute control algorithms, store data, retrieve data, gather data, and/or any other computing or controlling task desired. The controller 34 may be a single controller or may include more than one controller disposed to interact with various elements of the SHMS 30, receive data, provide instructions, and/or monitor the machine 10. Functionality of the controller 34 may be implemented in hardware and/or software and may rely on one or more data maps relating to structural health monitoring of the machine 10 and associated structural health events. To that end, the controller 34 may include or be otherwise associated with a memory 42, which may be internal memory or an external memory, such as a database or server. The memory 42 may include, but is not limited to including, one or more of read only memory (ROM), random access memory (RAM), a portable memory, and the like. Such memory media are examples of nontransitory memory media.

By utilizing the structural health data 38, provided by the sensors 32, the controller 34 may determine if one or more structural health events have occurred. Based on said data, the controller 34 may further be able to determine a location of said structural health events, relative to the machine 10, based on a known positioning of the member of the sensors 32, which provided the structural health data 38 that indicated existence of a structural health event. So that, for example, an operator 60 of the machine 10, or any other actor associated with said machine 10, may gain greater insight into the nature of structural health events and the causes thereof, the video cameras 36 may be specifically configured to selectively record the video data 40, in a manner having the intent of capturing the structural health event(s). Accordingly, while the video cameras may be configured to continuously monitor and record the video data 40, the controller 34 may be configured to only record the video data, to the memory 42, during a timeframe 44 associated with at least one structural health event, if the structural health event has occurred. As the video camera 36 may be positioned such that it is capable of viewing a structural health event when it occurs, such recorded video data, during the time frame, may show occurrence of the structural health event, as it relates to the machine 10.

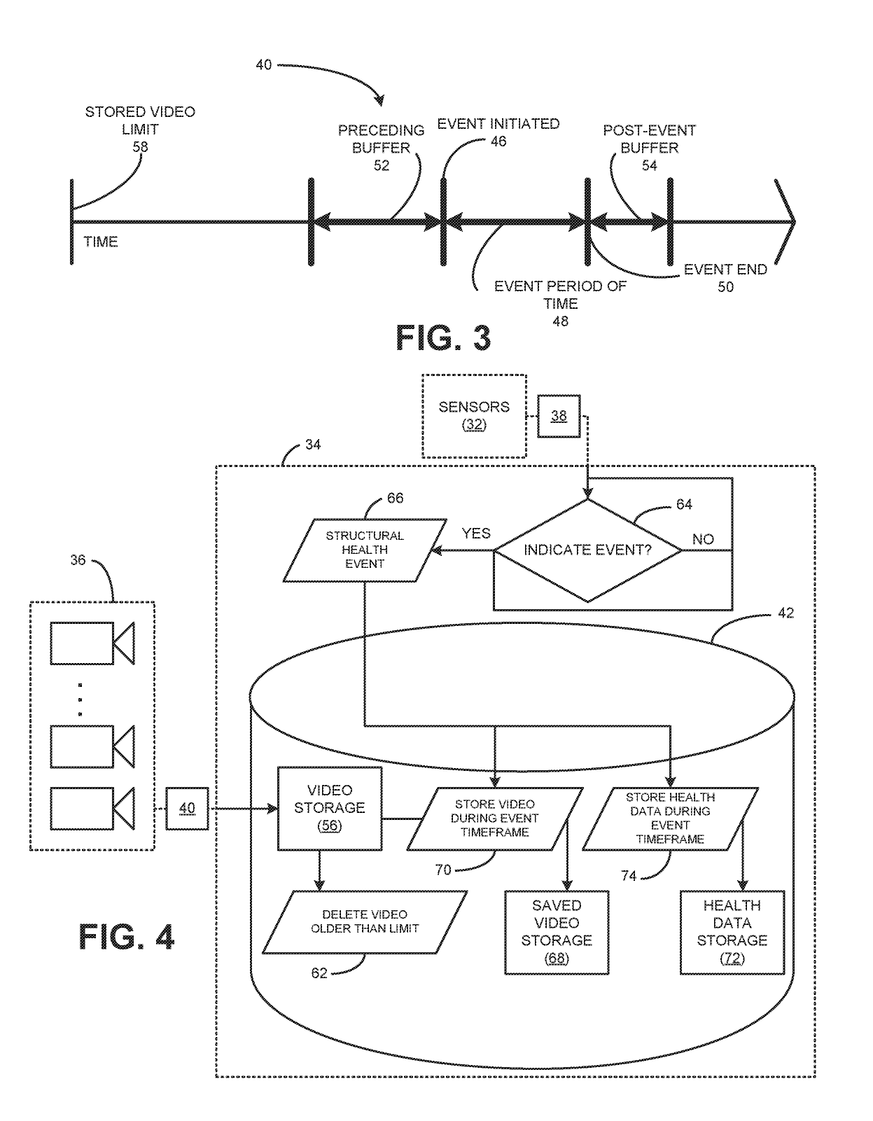

Accordingly, the controller 34 may be configured to only record, to the memory 42, video data that occurs during the timeframe 44, which is exemplified in a linear timeline in FIG. 3. The timeframe 44, and any optionally included portions thereof, is exemplified on the timeline of FIG. 3 by the significantly thicker, bolded lines and arrows overlaid on the timeline. The timeframe 44 may be based and configured around an event initiation moment in time 46, which is defined herein as the moment in time in which a structural health event begins or is noticed by the controller 34 and such notice is based on the structural health data. As shown, a structural health event commencing at the event initiation moment in time 46 and persists through an event period of time 48. The event period of time 48, as defined herein, is the period of time extending from the event initiation moment in time 46 through a period of time in which the structural health event is occurring and/or a period of time in which it is desired to monitor the location on the machine 10, in which the structural health event has occurred. To that end, the event period of time may end at an event end moment in time 50, which is a moment in time in which the structural health event either ceases to exist or wherein monitoring of said structural health event is no longer desired.

In some examples, the timeframe 44 may include one or both of a preceding buffer period in time 52 and a post-event buffer period in time 54. The preceding buffer period in time 52 may be any set period of time prior to the event initiation moment in time 46, which may be useful for capturing video data that occurred prior to initiation of the structural health event, to, for example, examine the stored video data, based on the timeframe 44 including the preceding buffer period in time 52, for a cause of the structural health event. The post-event buffer period in time 54 may be any set period of time after the event end moment in time 50, which may be useful for capturing video data that occurred capture of the structural health event, to, for example, ensure that the entire structural health event is captured in the stored video data.

Turning now to FIG. 4, a schematic diagram detailing instructions, decisions, and storage events, involving components of the SHMS 30, is illustrated to provide further explanation of data storage processes of the SHMS 30. The controller 34 may continuously receive the structural health data 38 from the sensors 32, during operation of the machine 10, and the controller 34 may, in some examples, continuously record the video data 40, to the memory 42, at a video storage 56 of the memory 42. The video storage 56 may act as a buffer for recorded video data 40, wherein the memory 42 may not hold a large amount of video data in the video storage 56, but rather, constrain the amount of video data held by the video storage 56 by a storage period of time constrained by a stored video limit 58. The stored video limit 58 may be any backward limit on the amount of time-based video data 40 that the video storage 56 may store, prior to deleting old video data. The stored video limit 58 may be configured, for example, to allow for enough stored time to exist in the video storage 56 such that the entire timeframe 44 may be saved to storage of the memory 42, in case of occurrence of a structural health event. Accordingly, in some examples, the stored video limit 58 may be in excess of the largest required event period of time 48, desired by the SHMS 30, plus any preceding buffer and/or post-event buffer periods of time 52, 54.

Accordingly, the video data 40 may be timestamped with relevant timing data by, for example, a clock 61 of the controller 34. To preserve storage space on the memory 42 and also preserve computational resources of the controller 34, the controller 34 may be configured to execute instructions 62, which are configured to continuously delete any video data 40 that was recorded to the video storage 56, prior to the storage period of time defined by the stored video limit 58.

As discussed above, the controller 34 may be configured to determine, based on the structural health data 38, if a structural health event has occurred. Accordingly, the controller 34 may be configured to continuously monitor incoming structural health data 38 and execute decision instructions 64, which determine if incoming data is indicative of a structural health event. If no structural health event is detected and the machine 10 is still in operation, then the controller 34 may continue to monitor the structural health data. Otherwise, if the controller 34 determines that a structural health event does exist, then indications to other instructional components of the controller 34 and/or SHMS 30 may be provided, as exemplified by the instructions 66. In some examples, the memory 42 may include structural health data storage 72. In such examples, the instructions 66 may invoke instructions 74, which instruct the controller 34 and/or memory 42 to store the structural health data 38, captured over the timeframe 44, to the structural health data storage 72.

In some examples, the controller 34 and/or memory 42 may be configured to store the video data over the timeframe 44, currently stored in the video storage 56, to a saved video storage 68 of the memory 42, as exemplified by the instructions 70. The saved video storage 68 may be configured to save the video data captured over the timeframe 44 to visually capture the structural health event(s). By moving such video data to the saved video storage 68, it will not be deleted from the memory 42, but rather will be saved for current or later use by an operator 60 for data analysis, operator coaching, or any other data-driven tasks.

To that end, the SHMS 30 may further include output device(s) 91, which may be configured to present the operator 60 with an indication 92 of at least one of the one or more structural health events. In such examples, the controller may be configured to instruct the output device(s) 91 to present the operator 60 with such an indication 92, if a structural health event has occurred. The output device(s) 91 may include, for example, a visual display configured to present selections from the video data 40 to the operator 60. In some additional or alternative examples, the controller 34 may be configured to provide the output device with operator coaching instructions 94 based, at least in part, on the video data associated with a structural health event. Using said coaching instructions 94, the operator 60 may be coached for optimal control of the machine 10, via, for example, the input control device(s) 95, to potentially avoid future structural health events.

As discussed above, the sensors 32 may include any sensors capable of determining structural health data 38. In some examples, the sensors 32 may include strain sensing device(s) 76, which may be configured to measure any type of strain. For example, strain sensing device(s) 76 may be configured to measure axial strain, shear strain, torsional strain, or even multi-axial strain (e.g., using a rosette type device). In some examples strain sensing device(s) 76 may utilize thin films attached to machine components of the machine 10 to detect strain. The resistance of such thin films may be altered with mechanical strain. Therefore, strain sensing device(s) 76 that employ such thin films may measure strain by detecting a change in resistance of the thin film. In some alternative examples of strain sensing device(s) 76, a strain sensing device 76 may utilize a piezoelectric transducer (PZT) material. PZT materials may generate electrical power upon experiencing strain; thus, strain sensing devices that employ PZT materials may be able to generate power, as opposed to thin, film-based strain sensing devices, which consume power in order to detect the changing resistance of the film. By generating its own power, such strain sensing device(s) 76 may be configured to operate substantially or completely independent of an external power source.

Further, the sensors 32, in some examples, may include one or more orientation sensor(s) 78, hydraulic pressure sensor(s) 80, cylinder position sensor(s) 82, position sensor(s) 84, velocity sensor(s) 86, load pins 88, and/or bending bridges 90, among other sensors. The orientation sensor(s) 78 may be one or more inclinometers disposed on machine 10 to measure one or both of pitch and roll of machine 10 relative to the Earth. Further, the hydraulic pressure sensor(s) 80 may be associated with a hydraulic system to detect fluid pressure in machine components such as, but not limited to, actuator(s) 28. The cylinder position sensor(s) 80 may be configured to sense the movement and relative position of one or more components of machine. Further, position sensor(s) 84 may be operatively coupled to actuators and/or joints of the machine 10, to determine positioning, and may include, for example, length potentiometers, radio frequency resonance sensors, rotary potentiometers, machine articulation angle sensors and the like. Velocity sensor(s) 86 may include accelerometer or other types of sensors configured to monitor acceleration and properly detect acceleration at any desired point, from such accelerations, velocities may be derived. Load pins 88 may be configured to measure force in x and y-axes in inner and outer shear planes of a pin and may be instrumented with, for example, one or more strain gauges. Further, bending bridges 90 may be configured to measure strain in or along surfaces. Of course, the sensors 32 are certainly not limited to including only the aforementioned sensors, and it is not a requirement that the sensors 32 include each of the aforementioned sensors; the sensors 32 may include any number of sensors 32 needed to properly obtain the structural health data 38.

### INDUSTRIAL APPLICABILITY

The present disclosure relates generally relates to structural health monitoring systems and methods, for machines, and, more particularly, relates to utilization of video data, associated with structural health events, in such structural health monitoring systems and methods. By utilizing video cameras in conjunction with sensors to capture video of affected areas on a machine, during operation, more accurate data and/or operator coaching may be achieved through analysis of said captured video. Further, because the video captured by the systems and methods of the present disclosure is continuously cleared of non-needed data, data storage reliance, data transfer reliance, and computational efficiency may all be improved, in comparison to prior art systems.

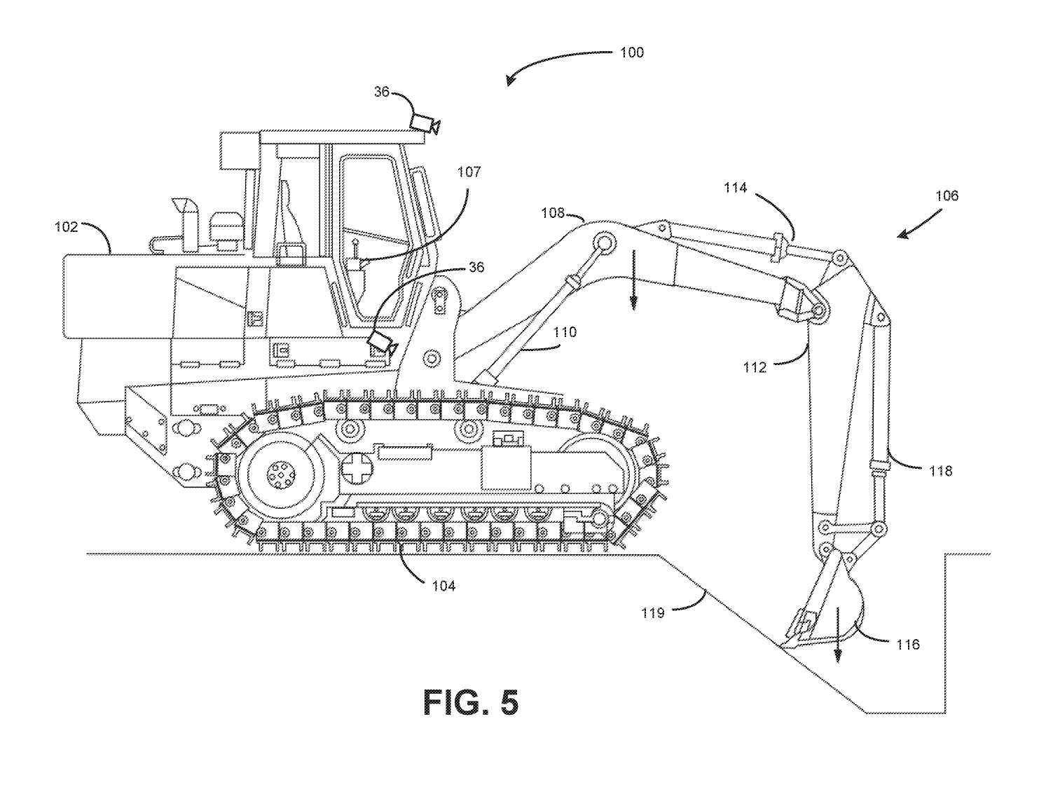

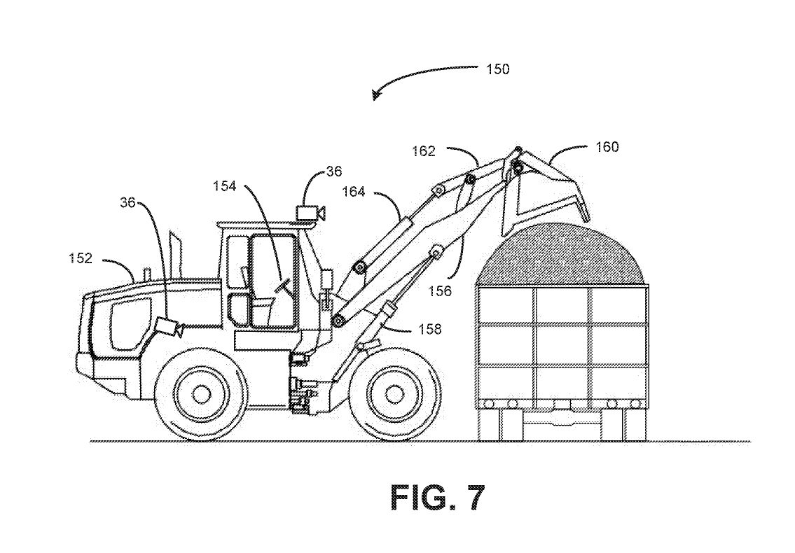

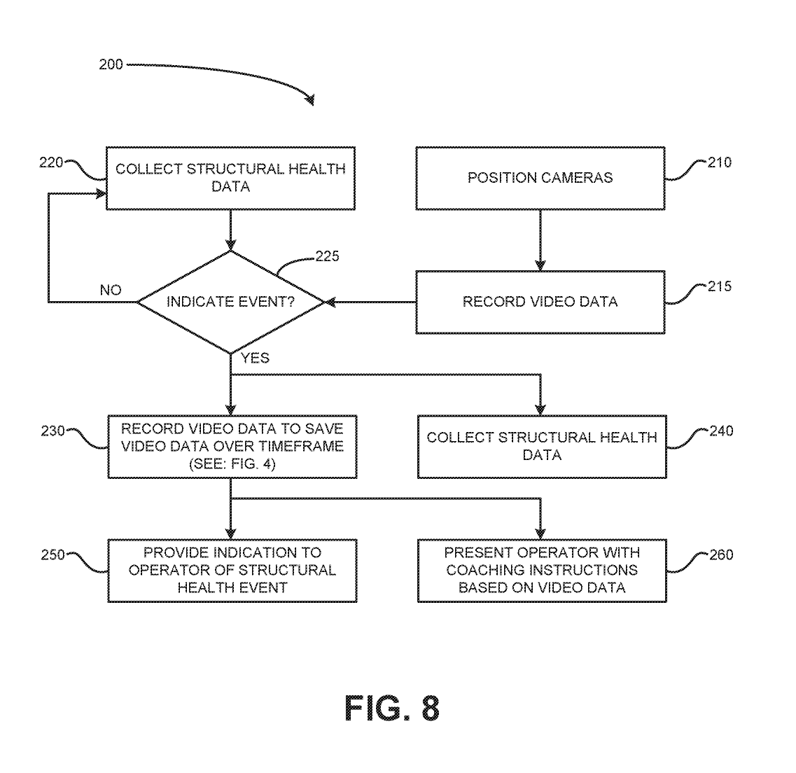

As discussed above, the systems and methods of the present disclosure, such as the SHMS 30 and the method 200, discussed below, are not limited to use with the machine 10, shown in FIG. 1. To the contrary, the systems and methods of the present disclosure may be applicable to any machine that performs some type of operation associated with an industry such as mining, construction, farming, transportation, or any other industry known in the art, such as the machines shown in FIG. 5-7 and discussed below.

Turning to FIG. 5, an excavator 100 is shown. The excavator 100 may have an engine 102, tracks 104 for propulsion, and an implement 106 for use in performing a work function (e.g., digging). The implement 106 may include a boom 108 and a boom cylinder 110 used to raise and lower the boom 108. The implement 106 may also include a stick 112 that extends and retracts using a stick cylinder 114 and may further include a tool, such as a bucket 116, which rotates using a bucket cylinder 118. In operation, the excavator 100 may use combinations of cylinder positions to engage the bucket 116 into a dig site to remove material and then to maneuver the bucket 116 to dump the material away from the dig site or into a dump truck or the like. As shown, the cameras 36 may be positioned relative to the excavator 100 and, accordingly, utilizing the SHMS 30, structural health monitoring, with all the benefits discussed above, may be performed.

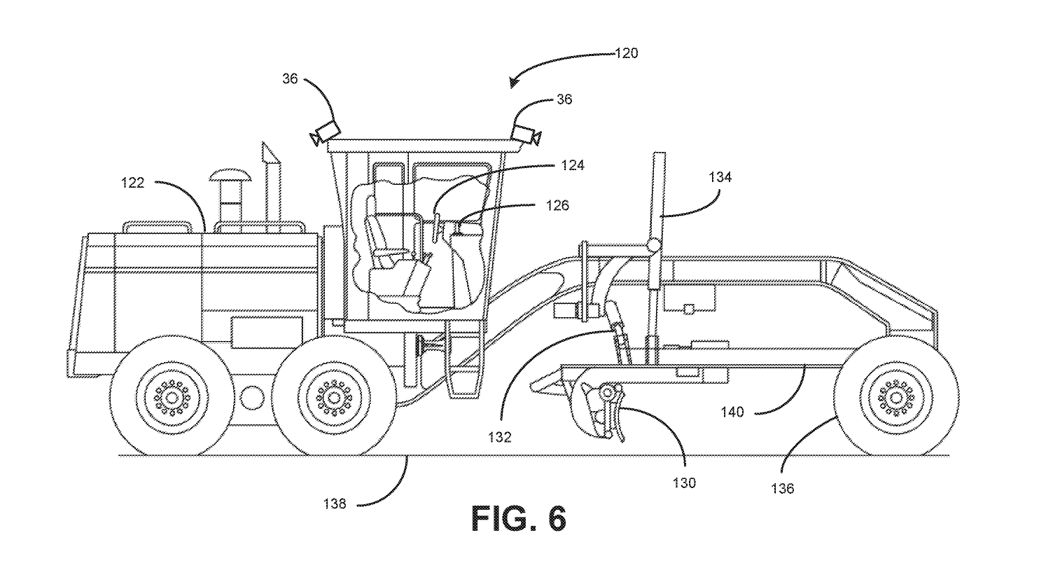

Further, FIG. 6 illustrates a grader 120 having a motor 122, a steering wheel 124, blade control 126, a blade 130, a blade angle cylinder 132 and a height cylinder 134. The grader 120 may include steerable wheels 136. The grader 120 is configured to scrape and level a worksite 138 using the blade 130. As with the excavator 100 above, the grader 120 may operate in several modes including a transport mode and a grading mode. As shown, the cameras 36 may be positioned relative to the motor grader 120 and, accordingly, utilizing the SHMS 30, structural health monitoring, with all the benefits discussed above, may be performed.

The systems and methods of the present disclosure may also be applicable to a wheel loader 150, as shown in FIG. 12. The wheel loader may include a motor 152, operator control 154, a boom 156, boom cylinder 158, and bucket 160. The bucket 160 may be rotated between a load position and dump position. As shown, the cameras 36 may be positioned relative to the excavator 100 and, accordingly, utilizing the SHMS 30, structural health monitoring, with all the benefits discussed above, may be performed.

By utilizing the systems and methods, herein, for structural health monitoring, data accuracy, memory storage, and computational efficiency may be improved. To that end, FIG. 8 illustrates a flowchart for an example method 200 for monitoring structural health of a machine. The method 200 is described, below, with reference to elements of the machine 10, and the SHMS 30, as described in detail above with reference to FIGS. 1-4. However, the method 200 is certainly not limited to application in conjunction with the machine 10 and the SHMS 30 and the method 200 is capable of being performed on or using other, machines and/or systems.

At block 210, the method may include positioning the video cameras 36, relative to the machine 10, such that the video data 40 shows a perspective at a location on the machine 10 in which a structural health event is able to occur. The video cameras 36 may then record video data 40 associated with the machine 10, as depicted in block 215. Concurrently, prior to, or after blocks 210, 215, the method 200 may include collecting structural health data 38, associated with the machine 10, by the sensors 32, as depicted in block 220. Based on the structural health data 38, the controller 34 may determine if one or more structural health events have occurred, as depicted with the decision 225. If no structural health event is detected, the method 200 continues to collect structural health data 38 at block 220.

Otherwise, if it is indicated that a structural health event has occurred or is currently occurring, the method 200 may store, at least in part, the video data 40 on the memory 42 during the timeframe 44, as depicted in block 230. A more detailed discussion of the mechanisms of storing said data and the machinations of the timeframe 44 are discussed in greater detail, above, with reference to FIGS. 3 and 4.

In some examples, block 240 is included, wherein, if a structural health event has occurred, the structural health data 38, over the timeframe 44, is recorded to the structural health data storage 72, as depicted in block 240. In some additional or alternative examples, the method 200 may include providing an operator 60 of the machine 10 with an indication 92 of the detected structural health event via, for example, the output device(s) 91, as depicted in block 250. Further, in some examples, the method 200 may include presenting the operator 60 with operator coaching instructions 94 based, at least in part, on the video data 40, via the output device 91, as depicted in block 260.

It will be appreciated that the present disclosure provides and systems and methods for developing machine operation classifiers using machine learning. While only certain embodiments have been set forth, alternatives and modifications will be apparent from the above description to those skilled in the art. These and other alternatives are considered equivalents and within the spirit and scope of this disclosure and the appended claims.

What is claimed is:

1. A system for monitoring structural health of a machine, the system comprising:
one or more sensors configured to collect structural health data associated with the machine;
one or more video cameras operatively associated with the machine and configured to selectively record video data; and
a controller, including a processor, operatively associated with the one or more sensors and the one or more video cameras, the controller configured to:
receive the structural health data from the one or more sensors,
determine if one or more structural health events have occurred, based on the structural health data, and
record the video data during a timeframe associated with at least one of the one or more structural health events, if at least one of the one or more structural health events has occurred, the video data showing occurrence of at least one of the one or more structural health events, relative to the machine.

2. The system of claim 1, wherein the one or more video cameras each are positioned, relative to the machine, such that the video data recorded shows a perspective at a location on the machine in which at least one of the one or more structural health events is able to occur.

3. The system of claim 1, wherein the controller further includes a memory configured to store the video data,
wherein the controller is further configured to:
continuously record the video data, during operation of the machine, by recording the video data to a video storage of the memory, the video storage having a stored video limit defined by a storage period of time, prior to a current moment in time, in which the video storage saves the recorded video data to the memory, and
continuously delete any video data recorded prior to the storage period of time.

4. The system of claim 3, wherein the timeframe includes, at least, an event period of time in which at least one of the one or more structural health events occurs, and
wherein the controller is further configured to store the video data, from the video storage, over the timeframe, on the memory, in a saved video storage of the memory.

5. The system of claim 4, wherein the timeframe further includes a preceding buffer period of time.

6. The system of claim 3, wherein the memory further includes an event structural health data storage, and
wherein the controller is further configured to store the structural health data collected over the timeframe.

7. The system of claim 1, wherein the machine includes an implement, and
wherein at least one of the one or more video cameras is positioned, relative to the machine, such that the video data recorded shows a perspective at a location on the machine in which the implement is visible and in which occurrence of at least one of the one or more structural health events, which is associated with the implement, is visible.

8. The system of claim 1, wherein the one or more sensors include one or more of strain sensing devices, orientation sensors, hydraulic pressure sensors, cylinder position sensors, position sensors, velocity sensors, load pins, bending bridges, and any combinations thereof.

9. The system of claim 1, further comprising and output device configured to present an operator of the machine with an indication of at least one of the one or more structural health events, and
wherein the controller is further configured to instruct the output device to present the operator of the machine with the indication of at least one of the one or more structural health events if one or more structural health events have occurred.

10. The system of claim 9, wherein the controller is further configured to provide the output device with operator coaching instructions based, at least in part, on the video data, if one or more structural health events have occurred.

11. A method for monitoring structural health of a machine, the method comprising:
collecting structural health data associated with the machine, using one or more sensors;
recording video data associated with the machine, using one or more video cameras associated with the machine;
determining, by an electronic controller, if one or more structural health events have occurred, based on the structural health data; and
storing, at least in part, the video data, on a memory associated with the controller, during a timeframe associated with at least one of the one or more structural health events, if at least one of the one or more structural health events has occurred, the video data showing occurrence of at least one of the one or more structural health events.

12. The method of claim 11, further comprising positioning the one or more video cameras, relative to the machine, such that the video data recorded shows a perspective at a location on the machine in which at least one of the one or more structural health events is able to occur.

13. The method of claim 11, wherein storing the video data includes continuously storing the video data, during operation of the machine, by storing the video data to a video storage of the memory, the video storage having a stored video limit defined by a storage period of time, prior to a current moment in time, in which the video storage saves the recorded video data to the memory, and
wherein the method further includes continuously deleting any video data stored prior to the storage period of time.

14. The method of claim 13, wherein the timeframe includes, at least, an event period of time, in which the one or more structural health events occurs, and
wherein storing the video data includes storing the video data, from the video storage, over the timeframe, on the memory, in a saved video storage of the memory.

15. The method of claim 11, further comprising storing the structural health data collected over the timeframe to a structural health data storage of the memory.

16. The method of claim 11, further comprising providing an operator machine, via an output device, with an indication of at least one of the one or more structural health events.

17. The method of claim 11, further comprising presenting an operator of the machine, via an output device, with operator coaching instructions based, at least in part, on the video data, if one or more structural health events have occurred.

18. A machine comprising:
a plurality of machine components including, at least, one or more ground engaging devices, a power system, and an implement;
one or more sensors configured to collect structural health data associated with one or more of the plurality of machine components;
one or more video cameras operatively associated one or more of the plurality of machine components, the video cameras configured to selectively record video data associated with one or more of the plurality of machine components; and
a controller, including a processor, operatively associated with the one or more sensors and the one or more video cameras, the controller configured to:
receive the structural health data from the one or more sensors,
receive the selectively recorded video data from the one or more video cameras;
determine if one or more structural health events have occurred, based on the structural health data, and
store the video data recorded by the one or more video cameras, during a timeframe associated with at least one of the one or more structural health events, if at least one of the one or more structural health events has occurred, the video data showing occurrence of at least one of the one or more structural health events, relative to one or more of the plurality of machine components.

19. The machine of claim 18, wherein the one or more video cameras are each positioned relative to one or more of the plurality of machine components, such that the video data recorded shows a perspective at a location on the machine in which at least one of the one or more structural health events is able to occur.

20. The machine of claim 18, wherein at least one of the one or more video cameras is positioned, relative to the implement, such that the video data recorded shows a perspective at a location on the machine in which the implement is visible and in which occurrence of at least one of the one or more structural health events, which is associated with the implement, is visible.
